(19) United States
(12) Patent Application Publication
(10) Pub. No.: US 2023/0062931 A1
(43) Pub. Date: Mar. 2, 2023

(54) USING DATA REDUCTION TO ACCELERATE MACHINE LEARNING FOR NETWORKING

(71) Applicant: Microsoft Technology Licensing, LLC, Redmond, WA (US)

(72) Inventors: Behnaz ARZANI, Redmond, WA (US); Ganesh ANANTHANARAYANAN, Seattle, WA (US)

(21) Appl. No.: 17/410,387

(22) Filed: Aug. 24, 2021

(51) Int. Cl. G06F 16/215; G06N 20/00

(52) U.S. Cl. CPC G06F 16/215; G06N 20/00

(57) ABSTRACT

The systems and methods may use a data reduction engine to reduce a volume of input data for machine learning exploration for computer networking related problems. The systems and methods may receive input data related to a network and obtain a network topology. The systems and methods may perform a structured search of a plurality of reduction functions based on a grammar to identify a subset of reduction functions. The systems and methods may generate transformed data by applying the subset of reduction functions to the input data and may determine whether the transformed data meets or exceeds a threshold. The systems and methods may output the transformed data in response to the transformed data meeting or exceeding the threshold.

### BACKGROUND

Machine learning is increasingly being used for various tasks in data center networks because of the benefits from the machine learning driven workflows. However, machine learning development takes time, specifically in the data exploration phase. The exploration phase is even more time-consuming in the networking domain due to the large volume and complexity of data.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method for reducing the volume of input data for machine learning exploration for computer networking related problems. The method may include receiving input data related to a network. The method may include obtaining a network topology. The method may include performing a structured search of a plurality of reduction functions based on a grammar to identify a subset of reduction functions, wherein the grammar is based on the network topology and other domain knowledge. The method may include generating transformed data by applying the subset of reduction functions to the input data. The method may include determining whether the transformed data achieves a threshold, wherein the threshold is a minimum acceptable accuracy for a given computer networking related problem. The method may include returning to a previous transformation of the data if the transformed data does not exceed the threshold. The method may include outputting the transformed data in response to the transformed data exceeding the threshold.

Another example implementation relates to a data reduction engine. The data reduction engine may include one or more processors; memory in electronic communication with the one or more processors; and instructions stored in the memory, the instructions executable by the one or more processors to: receive input data related to a network; obtain a network topology; perform a structured search of a plurality of reduction functions based on a grammar to identify a subset of reduction functions, wherein the grammar is based on the network topology and other domain knowledge; generate transformed data by applying the subset of reduction functions to the input data; determine whether the transformed data achieves a threshold, wherein the threshold is a minimum acceptable accuracy for a given computer networking related problem; return to a previous transformation of the data if the transformed data does not exceed the threshold; and output the transformed data in response to the transformed data exceeding the threshold.

Another example implementation relates to a method for defining a grammar for use with a data reduction engine. The method may include obtaining a network topology for a network, wherein the network topology provides network dependency rules for combining data. The method may include defining a set of rules for combining the data from different data sources within the network based on the network topology. The method may include generating a grammar based on the set of rules.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an existing solution for a machine learning development workflow.

FIG. 2 illustrates a machine learning development workflow in accordance with implementations of the present disclosure.

FIG. 3 illustrates an example environment for use with a data reduction engine in accordance with implementations of the present disclosure.

FIG. 4 illustrates an example machine learning development workflow using a data reduction engine in accordance with implementations of the present disclosure.

FIG. 5 illustrates an example method for reducing a volume of input data for machine learning exploration for computer networking related problems in accordance with implementations of the present disclosure.

FIG. 6 illustrates an example method for defining a grammar for use with a data reduction engine in accordance with implementations of the present disclosure.

### DETAILED DESCRIPTION

This disclosure generally relates to machine learning for networking related issues or problems. Machine learning exploration occurs before users know what machine learning model is going to work or what features may be appropriate for an issue or a problem. Machine learning is increasingly being used for various tasks in data center networks because of the benefits from the machine learning driven workflows. However, machine learning development takes time, specifically in the machine learning exploration phase. The exploration phase is even more time-consuming in the networking domain due to the large volume and complexity of data.

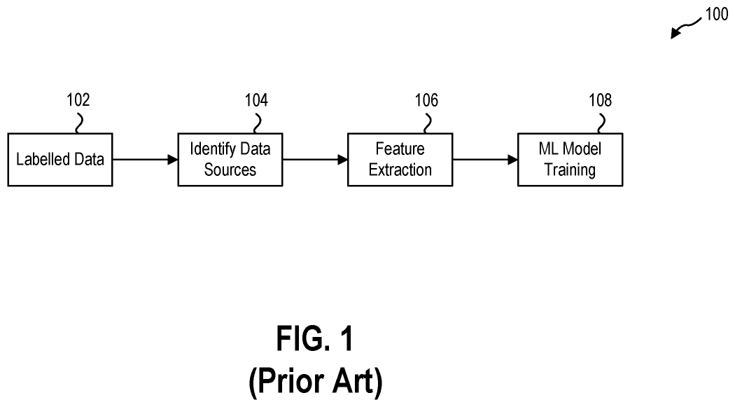

Referring now to FIG. 1, illustrated is a typical machine learning development workflow 100. A typical machine learning development workflow 100 involves data scientists working with a team of domain experts to receive or access labelled data 102; identify the set of data sources to use for solving the problem 104; identify feature extraction 106 that includes merging and creating features from this data (often involving joining multiple tables, and various mathematical operations over the data in those tables); and machine learning model training 108 that may explore various machine learning models accuracy. The typical machine learning development workflow 100 iterates over these steps until a model converges. After the machine learning model is trained the machine learning model may be deployed in production.

The cost of machine learning exploration (identifying the right model and the set of features to use for the machine learning model) using the machine learning development workflow 100 is an ever increasing factor in the time for development for network applications. The bandwidth, compute, and human-hour costs result in high turn-around times (often months) for machine learning development. On average identifying the right machine learning model may take around six months to a year. Such high turn-around times stifle creativity and the operator's (data scientist's) ability to quickly modify their approach and try out different techniques based on the output of the previous steps.

The present disclosure provides methods and systems for a data reduction engine that may speed up the machine learning exploration for machine learning models for network related issues by reducing the volume of data while achieving an acceptable accuracy for the machine learning model. The data reduction engine finds a smaller dataset that is a subset or transformation of a larger initial dataset. The smaller dataset may provide the same information or roughly the same level of information as the initial dataset and may be easier to work with during machine learning exploration.

However, building data reduction engines for networking is challenging due to the large search space, circular dependency, and the tradeoff between cost, fidelity, and granularity of various data sources across the network. For example, the data may be obtained from various vantage points of the network and at various levels of granularity where the various vantage points may have different costs for obtaining the data. In addition, the data reduction engine needs to find a representation of the data such that users may find a machine learning model and a set of features using that data to achieve sufficient accuracy without knowing the model and the features a priori. Moreover, the search space of possible strategies for reducing the data is so large that an exhaustive search is too expensive and takes too long.

The data reduction engine of the present disclosure uses network-structural insights from the network topology of the network in combination with a grammar based on the network topology to conduct a structured search of the reduction functions space for reducing the input data (networking related data). The data reduction engine uses the grammar to reduce the search space of the reduction functions. The structured search identifies reduction functions or transformations to apply to the input data. The data reduction engine uses a structured search based on the grammar and the network topology to select a set of reduction functions to apply to the input data to generate transformed data, which is a subset of the input data.

The present disclosure augments the current machine learning development workflow (e.g., the machine learning development workflow 100) with a data reduction engine that identifies a minimum cost subset of data that users (e.g., a data scientists or analysts) may need to work with during machine learning development. The minimum cost subset may still produce sufficiently high accuracy for the machine learning model.

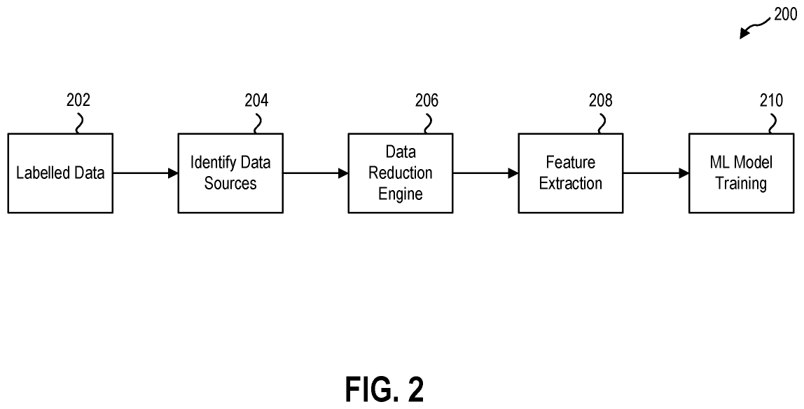

Referring now to FIG. 2, illustrated is an example of a machine learning development workflow 200 with a data reduction engine 206. The machine learning development workflow 200 may be used to identify one or more machine learning models for use with a machine learning task for a networking related issues or problems. The machine learning development workflow 200 includes collecting labelled data 202. The labelled data 202 may include labels with network information, such as, but not limited to, device and/or network components information. As such, the labelled data 202 may identify which device or component obtained the data. The machine learning development workflow 200 also includes identifying data sources 204 to use for the machine learning models. The data may be obtained from various data sources of the network and at various levels of granularity.

The machine learning development workflow 200 includes a data reduction engine 206 that returns a version of the data that contains the core information necessary to learn the outcome of interest with sufficient accuracy (close to what would have been achieved using the original data instead of a reduced amount of data). The machine learning development workflow 200 performs feature extraction 208 on the reduced set of data output from the data reduction engine 206 and performs machine learning model training 210 with the reduced set of data to identify one or more machine learning models to use for a machine learning task for a networking related issues or problems. The efficiency of the machine learning development workflow 200 may be improved by adding the data reduction engine 206 to the machine learning development workflow 200.

One technical advantage of the present disclosure is using the data reduction to reduce the volume and complexity of data used during the machine learning development workflow and speeding up the machine learning development workflow.

The present disclosure provides a data reduction engine that uses a structured search to identify a best combination of reduction functions to use on the input data to provide transformed data that is a subset or a transformation of the initial input data while maintaining an acceptable accuracy for the machine learning models for the machine learning task. The data reduction engine may use a network based grammar to handle tradeoffs between cost and utility of the input data. The network based grammar may reduce the search space of the reduction functions by performing a structured search of the reduction functions and pruning the reduction functions based on data properties. The present disclosure may help users (e.g., data scientists and network operators) be more productive in designing machine learning solutions for production for answering questions for networking related issues or problems using a machine learning task.

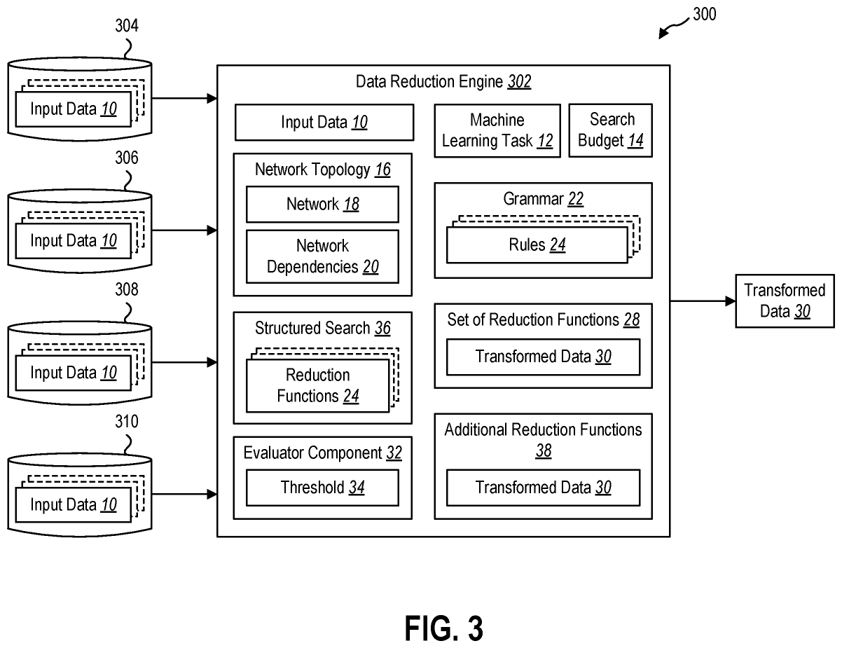

Referring now to FIG. 3, illustrated is an example environment 300 for a data reduction engine 302 to reduce input data 10 received for a network 18. The data reduction engine 302 may obtain or otherwise receive a machine learning task 12. In an implementation, the machine learning task 12 is a network related issue or problem a user is trying to address or solve using a machine learning model. Examples of a network related question to answer using machine learning include, but are not limited to, resource management issues, diagnosis issues, attack detection, energy efficiency, and/or other management tasks in datacenters. The data reduction engine 302 may identify a minimum cost subset of the input data 10 to use for the machine learning task 12 with an acceptable accuracy within any time limits or other constraints provided in a search budget 14. The data reduction engine 302 may output transformed data 30 (the subset of the input data 10) to use in machine learning modeling to identify one or more machine learning models to use for the machine learning task 12. As such, the data reduction engine 302 returns a version of the input data 10 that contains the core information necessary to learn the outcome of interest with sufficient accuracy.

The environment 300 may include a plurality of datastores 304, 306, 308, 310 with the input data 10 in communication with the data reduction engine 302. The input data 10 includes data obtained from the network 18. The input data 10 may include metadata annotations regarding how the input data 10 was collected by the network 18 (e.g., which device or component collected the input data 10) and/or other network information. The utility of the input data 10 for the machine learning task 12 may be very task dependent.

The input data 10 may be distributed across the plurality of datastores 304, 306, 308, 310 across the network 18. The input data 10 may contain redundant information, allowing for more reduction opportunities for network relating data. As such, different datastores 304, 306, 308, 310 may have the same networking information or data. Different datastores 304, 306, 308, 310 may have different levels of granularity of input data 10. In addition, different datastores 304, 306, 308, 310 may have different costs for obtaining the input data 10. For example, the datastore 304 may include the input data 10 from every ToR in the network 18, the datastore 306 may include the input data 10 from switches in tier one of the network 18, the datastores 308 may include the input data 10 from switches in tier two of the network 18, and the datastore 310 may include the input data 10 from different virtual machines in the network 18. As such, the cost to log and acquire the input data 10 from the different datastores 304, 306, 308, 310 may vary drastically.

One or more datastores 304 may have the same relevant input data 10 for the machine learning task 12 captured from different aspects of the network 18. An example use case includes a virtual machine failed. Relevant network information for the virtual machine may be extracted at many levels in the network 18, such as virtual switches (vSwitches), top-of-rack (TOR) switches, tier 0 (T0) switches, etc. Information gathered at the vSwitch is of higher fidelity compared to the TOR switch, as the vSwitch is closer to the virtual machine. Moreover, the information that may be gathered across the different levels of the network 18 also varies. For example, access to simple network management protocol (SNMP) logging information may only occur at tier 1 (T1) switches and not anywhere else. The acquisition cost of the data, in terms of transfer time is also quite different. The acquisition cost of data from a tier 2 (T2) switch might be lower if the T2 switch is hosted on a powerful high throughput SQL server, whereas a “vSwitch” might be higher if the vSwitch is hosted on a slower blob storage.

As such, the volume of the input data 10 available for the data reduction engine 302 for the network 18 may be quite large with complex data. In an implementation, a subset of the datastores 304, 306, 308, 310 across the network 18 are selected for the input data 10 based on the varying costs, fidelity, and/or granularity of the input data 10 for the machine learning task 12. Selecting a subset of the datastores 304, 306, 308, 310 for the input data 10 may be beneficial in aiding the data reduction engine 302 in reducing the input data 10 and achieving the acceptable accuracy of the minimum cost subset of the input data 10 within any time guarantees.

The data reduction engine 302 may also obtain a network topology 16 for the network 18. The network topology 16 defines the structure or the architecture of the network 18. The structure of the network 18 may be used to identify the network dependencies 20 and/or any network dependency rules for the input data 10. Different networks 18 may had different network topologies 16. In addition, different networks 18 may have the same or similar network topologies 16. In an implementation, a user (e.g., a network administrator, a data scientist, or analysist) provides the network topology 16 as an input to the data reduction engine 302. In another implementation, the network topology 16 is automatically retrieved by the data reduction engine 302 from the network 18.

In some implementations, the data reduction engine 302 may define a grammar 22 based on the network topology 16 and other domain knowledge to use in reducing the input data 10. The grammar 22 provides a set of rules or policies for applying reduction functions 24 to the input data 10. The grammar 22 may provide rules for combining the reduction functions 24 (e.g., reduction functions 24 can be applied to the input data 10 from switches in tier 1 of the network 18, or the input data 10 from virtual machines cannot be combined with the input data 10 from a switch). The grammar 22 may provide constraints or restrictions on how the input data 10 may be combined or reduced using one or more reduction functions 24. The grammar 22 may be a general rule set based on the network dependencies 20 for combining or reducing the input data 10. The grammar 22 may also be used to identify which input data 10 to use from the different datastores 304, 306, 308, 310 with the reduction functions 24. In some implementations, the grammar 22 may be globally defined for the entire network 18. In some implementations, the grammar 22 may be provided to the data reduction engine 302 as an input.

The data reduction engine 302 may use the grammar 22 to define a structured search 36 of the reduction functions 24. The structured search 36 may identify a set of reduction functions 28 to use on the input data 10 to transform the input data 10 by reducing and/or combining the input data 10 together. One example reduction function 24 includes reducing the number of data samples or row sampling. Another example reduction function 24 includes eliminating entire sets of data attributes of column samples. Another example reduction function 24 includes matrix sampling or aggregation. Another example reduction function 24 includes summarizing predicates that combine a set of column or rows to produce a smaller representation of the information contained in the set of column or rows. Another example reduction function 24 includes dimensionality reduction (e.g., principal component analysis (PCA) or t-Distributed Stochastic Neighbor Embedding (TSNE)). Another example reduction function 24 includes join-optimizations. The search space of the reduction functions 24 may be voluminous. An example equation of search space of the reduction functions 24 includes:

G(K^{N}) (1),

where K is the number of possible reduction functions, N is the number of reductions functions that can be run in the given search budget 14, and G is a composition of many such transformations functions applied in the correct order. For example, K and N may be in the few tens of options. As such, the search space of the reduction functions 24 is non-negligibly large.

The data reduction engine 302 may tailor the structured search 36 of the reduction functions 24 based on the machine learning task 12. As such, different reduction functions 24 may be selected for transforming the input data 10 based on the machine learning task 12. Moreover, the order of applying the reduction functions 24 may change based on the machine learning task 12.

The structured search 36 may use the rules or policies defined by the grammar 22 to identify which reduction functions 24 may be used in combination with each other. For example, the rules or policies may include dropping older samples or looking for distinct values of specific attributes. Another example of the rules or polices may include, for aggregation, which attributes to group the input data 10 by and the type of summarization to apply to the input data 10.

The grammar 22 may add structure to the search process. The structured search 36 may ensure that the selected reduction functions 24 satisfy the rules or restrictions established by the grammar 22. The selected reduction functions 24 may be added to the set of reduction functions 28. As such, the structured search 36 may be a guided search by the grammar 22 driven by domain specific insights of the network topology 16. The structured search 36 may be used to efficiently identify a set of reduction functions 28 to use on the input data 10 to generate transformed data 30, which is smaller in size than the original set of input data 10.

The structured search 36 may identify a set of reduction functions 28 (e.g., a first set of reduction functions) that comply with the rules or polices of the grammar 22 to generate the transformed data 30. An evaluator component 32 may compare the transformed data 30 to a threshold 34 to determine whether the transformed data 30 meets an acceptable accuracy for a machine learning model. The threshold 34 may set a minimum level of accuracy (e.g., 90%) for a machine learning model to learn an outcome of interest for the machine learning task 12 with sufficient accuracy. The evaluator component 32 may emulate a user (e.g., a data scientist or analyst) evaluating the transformed data 30 to determine whether the transformed data 30 may produce a sufficient accuracy for use with a machine learning model.

The evaluation component 32 may emulate the application of the machine learning development workflow or emulate the application of a machine learning model with various data reduction functions. For each scenario (e.g., use case and data reduction function), the evaluator component 32 may record the memory and time taken to run the data reduction function (e.g., the set of reduction functions 28) and the accuracy achieved by a final machine learning model trained on the reduced dataset of the transformed data 30. In an implementation, the evaluator component 32 includes an auto machine learning system that evaluates the utility of the reduced dataset of the transformed data 30. The evaluator component 32 may automatically identify a machine learning model to use and get an estimate for the accuracy of the transformed data 30.

The evaluation component 32 may compare the accuracy to the threshold 34. If the transformed data 30 is below the threshold 34, the data reduction engine 302 may continue the structured search 36 and identify another set of reduction functions 28 (e.g., a second set of reduction functions) to use with the input data 10 and use the evaluator component 32 to compare the transformed data 30 to the threshold 34.

If the transformed data 30 meets or exceeds the threshold 34, the data reduction engine 302 may output the transformed data 30 for use, for example, in the machine learning development workflow 200 (FIG. 2). The transformed data 30 may also be used for training a machine learning model for the machine learning task 12.

In addition, if the transformed data 30 meets or exceeds the threshold 34, the data reduction engine 302 may continue the structured search 36 to identify additional reduction functions 38 to add to the set of reduction functions 28 to generate the transformed data 30. The evaluator component 32 may compare the transformed data 30 based on the additional reduction functions 38 to the threshold 34. If the transformed data 30 meets or exceeds the threshold 34, the additional reduction functions 38 may be added to the set of reduction functions 28. If the transformed data 30 is below the threshold 34, the set of reduction functions 28 may be ignored and the data reduction engine 302 may use a previous set of reductions functions 28 that met or exceeded the threshold level 34. The structured search 36 may continue until the input data 10 can no longer be reduced (e.g., the transformed data 30 is below the threshold 34 for acceptable accuracy).

The data reduction engine 302 may also obtain or otherwise receive a search budget 14. The search budget 14 may provide constraints for developing or identifying a machine learning model for the machine learning task 12. The constraints may include costs (e.g., time, bandwidth) for the machine learning development workflow 200. In an implementation, the structured search 36 may continue until the search budget 14 is met. Upon reaching the search budget 14, the transformed data 30 based on the set of reduction functions 28 may be output from the data reduction engine 302. Thus, even if additional reduction functions 38 may be added to the transformed data 30 because the transformed data 30 may still be reduced (e.g., the transformed data 30 exceeded the threshold 34), upon the search budget 14 being met, the structured search 36 may stop.

As such, the data reduction engine 302 may use the grammar 22 and the network topology 16 to select a set of reduction functions 28 that satisfy the rules of the grammar 22 and/or any network dependencies 20 to reduce the input data 10 within the constraints of the search budget 14.

The environment 300 may have multiple machine learning models running simultaneously. For example, the evaluator component 32 includes an auto machine learning system. Another example includes using one or more machine learning models to perform the structured search 36 of the reduction functions 24.

In some implementations, one or more computing devices are used to perform the processing of environment 300. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the data reduction engine 302 is implemented wholly on the same computing device. Another example includes one or more subcomponents of the data reduction engine 302 and/or the datastores 304, 306, 308, 310 implemented across multiple computing devices. Moreover, in some implementations, the one or more subcomponents of the data reduction engine 302 and/or the datastores 304, 306, 308, 310 are implemented or processed on different server devices of the same or different cloud computing networks.

In some implementations, each of the components of the environment 300 is in communication with each other using any suitable communication technologies. In addition, while the components of the environment 300 are shown to be separate, any of the components or subcomponents may be combined into fewer components, such as into a single component, or divided into more components as may serve a particular embodiment. In some implementations, the components of the environment 300 include hardware, software, or both. For example, the components of the environment 300 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 300 include hardware, such as a special purpose processing device to perform a certain function or group of functions. In some implementations, the components of the environment 300 include a combination of computer-executable instructions and hardware.

The data reduction engine 302 may use the structured search 36 in combination with the evaluator component 32 to identify a best combination of reduction functions 24 to use on the input data 10 to provide the transformed data 30 that is a subset or a transformation of the initial dataset of the input data 10 while maintaining an acceptable accuracy for the machine learning models for the machine learning task 12.

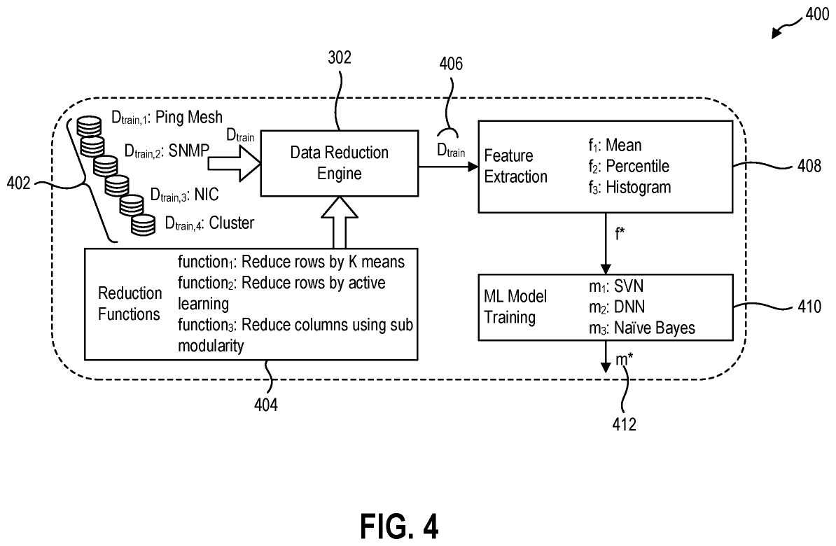

Referring now to FIG. 4, illustrated is an example environment 400 for using the data reduction engine 302 in a machine learning development workflow to identify a machine learning model for use with a machine learning task 12 (FIG. 3). The data reduction engine 302 may receive a set of training data 402. The set of training data 402 may include Ping Mesh data, simple network management protocol (SNMP) data, network interface controller (NIC) data, Cluster data. The set of training data 402 may be disbursed across a plurality of datastores across the network 18 (FIG. 3).

The data reduction engine 302 may apply three reduction functions 404 (e.g., the set of reduction functions 28) to the training data 402. The three reduction functions 404 include reducing the rows of the training data 402 by K means (where K is a positive integer), reducing the rows of the training data 402 by active means, and reducing the columns using sub-modularity. As such, the three reduction functions 404 may reduce the number of data samples of the training data 402 by performing row sampling or column sampling. While three reduction functions 404 are illustrated is this example, any number of reduction functions or combination of reduction functions may be applied to the training data 402 by the data reduction engine 302.

The data reduction engine 302 outputs transformed training data 406 based on applying the three reduction functions 404 to the training data 402. The transformed training data 406 minimizes the volume of the training data 402 while ensuring that the training data 402 achieves a target accuracy (e.g., close to the accuracy that may be achieved using the original training data 402) when used in a machine learning model.

Feature extraction 408 may be performed on the transformed training data 406 to identify a set of features (e.g., mean, percentile, histogram, aggregation, or various mathematical operations over the transformed training data 406) to use for merging the transformed training data 406 and/or creating features from the transformed training data 406. Machine learning model training 410 may be performed on the transformed training data 406 to explore various machine learning models (e.g., SVN, DNN, Naive Bayes) and the machine learning models accuracy to identify a machine learning model 412 for the machine learning task 12 with an acceptable accuracy.

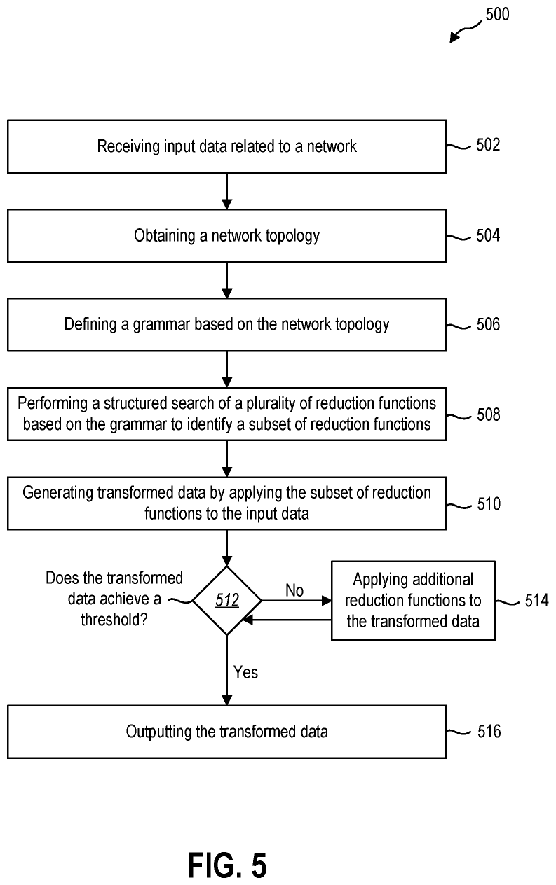

Referring now to FIG. 5, illustrated is an example method 500 for reducing a volume of input data 10 for machine learning exploration for machine learning tasks 12 for computer network related problems. The actions of the method 500 are discussed below with reference to the architecture of FIG. 3 but may be application to other specific environments.

At 502, the method 500 includes receiving input data related to a network. The data reduction engine 302 may receive or otherwise obtain input data 10 obtained from the network 18. The input data 10 may include metadata annotations identifying which device or component in the network 18 collected the input data 10 and/or other network information. The input data 10 may be distributed across a plurality of datastores 304, 306, 308, 310 of the network 18. Different datastores 304, 306, 308, 310 may have different levels of granularity of input data 10. In addition, different datastores 304, 306, 308, 310 may have different costs for obtaining the input data 10. As such, the cost to log and acquire the input data 10 from the different datastores 304, 306, 308, 310 may vary drastically across the network 18. Moreover, since the input data 10 may be distributed across the entire network 18 and the volume of traffic across the entire network 18 may be voluminous, the volume of the input data 10 may be quite large.

At 504, the method 500 includes obtaining a network topology. The data reduction engine 302 may also obtain a network topology 16. The network topology 16 may define the structure or the architecture of the network 18. The structure of the network 18 may be used to identify the network dependencies 20. In an implementation, a user (e.g., a network administrator, a data scientist, or analysist) provides the network topology 16 as an input to the data reduction engine 302. In another implementation, the network topology 16 is automatically retrieved from the network 18 by the data reduction engine 302.

At 506, the method 500 includes defining a grammar based on the network topology and other domain knowledge. In some implementations, the data reduction engine 302 may define a grammar 22 based on the network topology 16 to use in reducing the input data 10. The grammar 22 provides a set of rules or policies for applying reduction functions 24 to the input data 10. The grammar 22 may provide rules for combining the reduction functions 24 (e.g., reduction functions 24 can be applied to the input data 10 from switches in tier 1 of the network 18, or the input data 10 from virtual machines cannot be combined with the input data 10 from a switch). In addition, the grammar 22 may provide constraints or restrictions on how the input data 10 may be combined or reduced using one or more reduction functions 24. The grammar 22 may be a general rule set based on the network dependencies 20 for combining or reducing the input data 10. The grammar 22 may also be used to identify which input data 10 to use from the different datastores 304, 306, 308, 310 with the reduction functions 24. In some implementations, the grammar 22 may be globally defined for the entire network 18. In some implementations, the grammar 22 may be provided to the data reduction engine 302 as an input.

At 508, the method 500 includes performing a structured search of a plurality of reduction functions based on the grammar to identify a subset of reduction functions. The data reduction engine 302 may use the grammar 22 to define a structured search 36 of the reduction functions 24. The search space of the reduction functions 24 may be voluminous. The structured search 36 may identify a set of reduction functions 28 to use on the input data 10 to transform the input data 10 by reducing and/or combining the input data 10 together. The reductions functions 24 may reduce the volume of input data 10. The reduction functions 24 may be the underlying building blocks which the grammar 22 is defined over. Example reduction functions 24 include, but are not limited to, order statistics, mean, variance, autoencoders, t-SNE, and/or UMAP.

The structured search 36 may use the rules or policies defined by the grammar 22 to identify which reduction functions 24 may be used in combination with each other. For example, the rules or policies may include dropping older samples or looking for distinct values of specific attributes. Another example of the rules or polices may include, for aggregation, which attributes to group the input data 10 by and the type of summarization to apply to the input data 10.

The structured search 36 may reduce the input data 10 based on properties of the dataset (e.g., if the dataset has outliers, the structured search 36 may remove reduction functions 24 that are not robust to outliers). The structured search 36 may also use various statistical aggregates, such as, rank, outliers, entropy, and/or information gain to select reduction functions 24 for the set of reduction functions 28 and/or remove reduction functions 24 from consideration for the set of reduction functions 28.

The data reduction engine 302 may tailor the structured search 36 of the reduction functions 24 based on a received machine learning task 12. As such, different reduction functions 24 may be selected during the structured search 36 for transforming the input data 10 based on the machine learning task 12. Moreover, the order of applying the reduction functions 24 may change based on the machine learning task 12.

The data reduction engine 302 may also obtain or otherwise receive a search budget 14. The search budget 14 may provide constraints (e.g., time, bandwidth restrictions or limits) for developing or identifying a machine learning model for the machine learning task 12. The structured search 36 may terminate upon reaching the search budget 14. Thus, even if additional reduction functions 38 may be added to the transformed data 30 because the transformed data 30 may still be reduced (e.g., the transformed data 30 exceeded the threshold 34), upon the search budget 14 being met, the structured search 36 may stop.

The structured search 36 may ensure that the selected reduction functions 24 satisfy the rules or restrictions established by the grammar 22. The selected reduction functions 24 may be added to the set of reduction functions 28. As such, the structured search 36 may be a guided search driven by domain specific insights of the network topology 16. The grammar 22 may add structure to the search process and the structured search 36 may be used to efficiently identify a set of reduction functions 28 to use on the input data 10 to generate transformed data 30, which is smaller in size than the original set of input data 10.

At 510, the method 500 includes generating transformed data by applying the subset of reduction functions to the input data. The structured search 36 may identify a set of reduction functions 28 that comply with the rules or polices of the grammar 22 to generate the transformed data 30. The data reduction engine 302 may generate transformed data 30 by applying the set of reduction functions 28 to the input data 10.

At 512, the method 500 includes determining whether the transformed data achieves a threshold. An evaluator component 32 may compare the transformed data 30 to a threshold 34 to determine whether the transformed data 30 meets an acceptable accuracy for a machine learning model. The threshold 34 may set a minimum acceptable accuracy (e.g., 90%) for a given computer networking related problem. For example, the minimum acceptable accuracy may be for a machine learning model to learn an outcome of interest with sufficient accuracy. The evaluator component 32 may emulate a user (e.g., a data scientist or analyst) evaluating the transformed data 30 to determine whether the transformed data 30 may produce a sufficient accuracy for use with a machine learning model. For example, the evaluation component 32 may emulate the application of the machine learning development workflow (e.g., machine earning workflow 200) with various data reduction functions 24. The evaluator component 32 may evaluate the effectiveness of the transformed data 30 without human-in-the loop evaluation. In an implementation, the evaluator component 32 is an auto machine learning system that evaluates the utility of the transformed data 30 (e.g., the reduced dataset of the input data 10).

At 514, the method 500 includes applying additional reduction functions to the transformed data. If the transformed data 30 is below the threshold 34, the data reduction engine 302 may continue the structured search 36 and identify additional reduction functions 38 to use with the input data 10 and add the additional reduction functions 38 to the set of reduction functions 28. For example, the data reduction engine 302 may return to a previous transformation of the input data 10 if the transformed data 30 does not exceed the threshold 34.

In addition, if the transformed data 30 meets or exceeds the threshold 34, the data reduction engine 302 may optionally continue the structured search 36 to identify additional reduction functions 38 to add to the set of reduction functions 28 to generate the transformed data 30. The structured search 36 may continue until the transformed data 30 fails to produce a minimum acceptable level of accuracy (e.g., fails to exceed the threshold 34).

The method 500 may return to 512 and the evaluator component 32 may compare the transformed data 30 to the threshold 34. The steps 512, 514 of the method 500 may repeat until the transformed data 30 is able to meet the target accuracy (e.g., the threshold 34) or the structured search 36 runs out of maximum allowed time budget (e.g., exceeds the search budget 14). The steps 512, 514 of the method 500 may also repeat until the transformed data 30 fails to achieve the threshold 34 (e.g., fails to produce the minimum acceptable level of accuracy).

An example use case includes identifying a machine learning task for Phynet-Scout. The data reduction engine 302 may initially start with input data 10 from a tier 0 (T0) switch. The data reduction engine 302 may compute the statistical properties about the input data 10 from the TO switch and evaluate the transformed data 30 based on a set of reduction functions 28 (e.g., the selected reduction functions 24) using the evaluator component 32. Next, the data reduction engine 302 may apply a set of rules from the grammar 22 to traverse the network topology 16 and add the input data 10 from tier 1 (T1) switches as well to the transformed data 30. The data reduction engine 302 may again compute the statistical properties, apply additional reduction functions 38 to the set of reduction functions 28 and evaluate whether the transformed data 30 is able to achieve a target accuracy requirement (e.g., a threshold 34). This process (e.g., steps 512, 514 of the method 500) may repeated until the transformed data 30 is able to meet the target accuracy (e.g., the threshold 34) or the structured search 36 runs out of maximum allowed time budget (e.g., exceeds the search budget 14).

At 516, the method 500 includes outputting the transformed data. The data reduction engine 302 may output the transformed data 30 in response to the evaluator component 32 determining that the transformed data 30 meets or exceeds the threshold 34 (e.g., a target accuracy requirement of the transformed data 30). The transformed data 30 may be used for training a machine learning model for the machine learning task 12. In addition, the transformed data 30 may be used, for example, in the machine learning development workflow 200 (FIG. 2).

The method 500 may be used to reduce the input data 10 to identify a minimum cost subset of the input data 10 to use for machine learning exploration for identifying a machine learning model for the machine learning task 12 with an acceptable accuracy within any time limits (e.g., search budget 14 constraints). The method 500 uses a network based grammar 22 to handle tradeoffs between cost and utility of the input data 10 and to reduce the search space of the reduction functions 24 by performing a structured search of the reduction functions 24 and pruning the reduction functions 24 based on data properties. The method 500 may break circular dependencies by using an evaluator component 32 to estimate whether the transformed data 30 meets a threshold 34 (e.g., a baseline for an acceptable accuracy) without human evaluations.

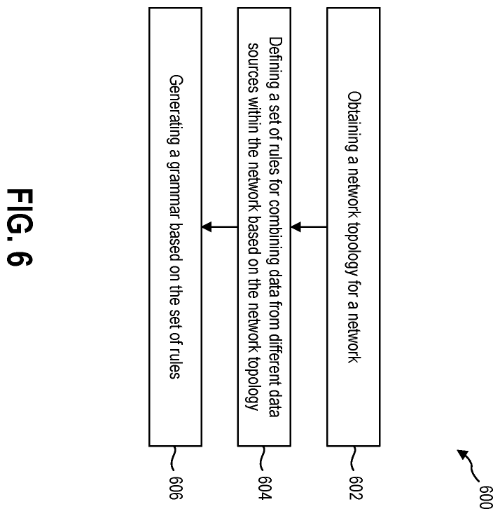

Referring now to FIG. 6, illustrated is an example method 600 for defining a grammar 22 (FIG. 3) for use with a data reduction engine 302 (FIG. 3). The actions of the method 600 are discussed below with reference to the architecture of FIG. 3 but may be application to other specific environments.

At 602, the method 600 includes obtaining a network topology for a network. The data reduction engine 302 may obtain or otherwise receive the network topology 16 for the network 18. The network topology 16 may identify the structure or architecture of the network 18. In addition, the network topology 16 may provide the network dependencies 20 for the network 18.

At 606, the method 600 includes defining a set of rules for combining data from different data sources within the network based on the network topology. The set of rules may include guidelines for a set of operations to allow or prevent based on the network topology 16 and/or any network dependencies 20. One example of a rule includes allowing the combination of the input data 10 from switches in the same tier of the network 18 (e.g., the data from all switches in the same topology tier may be summarized or otherwise combined). Another example rule includes preventing the combination of the input data 10 from a virtual machine and a switch. Another example rule includes data gathered from devices that are different in nature (e.g., a virtual machine or ToR) cannot be aggregated to provide a summary of statistics (unless certain properties hold). Another example rule includes allowing the combination of the input data 10 from across a path in the network 18 that dataflow is taking. Another example rule includes grouping policies. Another example rule includes policies defining the utility of each operation (e.g., fidelity, acquisition cost).

In an implementation, the data reduction engine 302 defines the set of rules based on the network topology 16. In an implementation, the set of rules may be provided as input to the data reduction engine 302. As such, the set of rules of the grammar 22 are defined over the network topology 16 and may restrict the possible operations (different types of reduction functions 24 and combination of the reduction functions 24) that may be performed over the input data 10.

At 606, the method 600 includes generating a grammar based on the set of rules. The data reduction engine 302 may generate the grammar 22 based on the set of rules. The grammar 22 provides a set of guidelines for operations that may be performed on the input data 10 and/or a set of guidelines for combining reduction functions 24. The grammar 22 may be defined globally for the entire network 18.

The grammar 22 may be used by the data reduction engine 302 to provide structure to a search process over operations to use for reducing the input data 10 and/or the available reduction functions 24 for reducing the input data 10. The data reduction engine 302 may use the grammar 22 to conduct an efficient search procedure over the input to the data reduction engine 302 (e.g., a set of disparate datasets collected from various parts of the network 18 and the relationship of the datasets to network components).

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a binary model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include random access memory (RAM), read-only memory (ROM), electrically erasable programmable read-only memory (EEPROM), compact disc read-only memory (CD-ROM), solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for reducing the volume of input data for machine learning exploration for computer networking related problems, comprising:
receiving input data related to a network;
obtaining a network topology;
performing a structured search of a plurality of reduction functions based on a grammar to identify a subset of reduction functions, wherein the grammar is based on the network topology and other domain knowledge;
generating transformed data by applying the subset of reduction functions to the input data;
determining whether the transformed data achieves a threshold, wherein the threshold is a minimum acceptable accuracy for a given computer networking related problem;
returning to a previous transformation of the data if the transformed data does not exceed the threshold; and
outputting the transformed data in response to the transformed data exceeding the threshold.

2. The method of claim 1, wherein the grammar includes one or more rules for combining the input data or combining different reduction functions of the plurality of reduction functions.

3. The method of claim 2, wherein the subset of reduction functions satisfy the one or more rules of the grammar.

4. The method of claim 2, wherein identifying the subset of reduction functions further includes:
selecting at least two reduction functions from the plurality of reduction functions;
determining whether the one or more rules of the grammar allow combining the at least two reduction functions;
if the one or more rules are satisfied, adding the at least two reduction functions to the subset of reduction functions; and
if the one or more rules are not satisfied, selecting different reduction functions for the subset of reduction functions.

5. The method of claim 1, further comprising:
receiving a search budget that provides constraints on a time for performing the structured search or bandwidth limits for performing the structured search; and
performing the structured search within the search budget.

6. The method of claim 1, wherein the threshold is a baseline level of accuracy of a machine learning model using the transformed data.

7. The method of claim 1, further comprising:
if the transformed data is below the threshold, applying additional reduction functions to the transformed data until the transformed data exceeds the threshold.

8. The method of claim 1, wherein an auto machine learning model determines whether the transformed data exceeds the threshold by emulating an application of a machine learning model to the transformed data.

9. The method of claim 1, wherein the network topology includes a structure of the network and network dependencies.

10. The method of claim 1, wherein the transformed data is used in training a machine learning model for the machine learning task.

11. A data reduction engine, comprising:
one or more processors;
memory in electronic communication with the one or more processors; and
instructions stored in the memory, the instructions executable by the one or more processors to:
receive input data related to a network;
obtain a network topology;
perform a structured search of a plurality of reduction functions based on a grammar to identify a subset of reduction functions, wherein the grammar is based on the network topology and other domain knowledge;
generate transformed data by applying the subset of reduction functions to the input data;
determine whether the transformed data achieves a threshold, wherein the threshold is a minimum acceptable accuracy for a given computer networking related problem;
return to a previous transformation of the data if the transformed data does not exceed the threshold; and
output the transformed data in response to the transformed data exceeding the threshold.

12. The data reduction engine of claim 11, wherein the grammar includes one or more rules for combining the input data or combining different reduction functions of the plurality of reduction functions.

13. The data reduction engine of claim 12, wherein the subset of reduction functions satisfy the one or more rules of the grammar.

14. The data reduction engine of claim 11, wherein the one or more processors are further operable to:
receive a search budget that provides constraints on a time for performing the structured search or bandwidth limits for performing the structured search; and
perform the structured search within the search budget.

15. The data reduction engine of claim 11, wherein the threshold is a baseline level of accuracy of a machine learning model using the transformed data and an auto machine learning model determines whether the transformed data exceeds the threshold by emulating an application of the machine learning model to the transformed data.

16. The data reduction engine of claim 11, wherein the one or more processors are further operable to:
apply additional reduction functions to the transformed data until the transformed data exceeds the threshold if the transformed data is below the threshold.

17. The data reduction engine of claim 11, wherein the network topology includes a structure of the network and network dependencies.

18. A method for defining a grammar for use with a data reduction engine, comprising:
obtaining a network topology for a network, wherein the network topology provides network dependency rules for combining data;
defining a set of rules for combining the data from different data sources within the network based on the network topology; and
generating a grammar based on the set of rules.

19. The method of claim 18, wherein the grammar is globally defined for the entire network.

20. The method of claim 18, wherein the grammar restricts use of reduction functions on the data by defining policies for combining the data or combining different reduction functions.
